(19) United States
(12) Patent Application Publication
(10) Pub. No.: US 2025/0183545 A1
(43) Pub. Date: Jun. 5, 2025

(54) RADIO WAVE REFLECTOR

(71) Applicants: NATIONAL INSTITUTE OF INFORMATION AND COMMUNICATIONS TECHNOLOGY, Tokyo (JP); TOKYO INSTITUTE OF TECHNOLOGY, Tokyo (JP); Maxell, Ltd., Kyoto (JP); TOKYO UNIVERSITY OF SCIENCE FOUNDATION, Tokyo (JP)

(72) Inventors: Masao FUJITA, Otokuni-gun, Kyoto (JP); Masayuki TOYODA, Otokuni-gun, Kyoto (JP); Sangyeop LEE, Tokyo (JP); Kyoya TAKANO, Tokyo (JP); Shinsuke HARA, Tokyo (JP); Issei WATANABE, Tokyo (JP); Akifumi KASAMATSU, Tokyo (JP)

(73) Assignees: NATIONAL INSTITUTE OF INFORMATION AND COMMUNICATIONS TECHNOLOGY, Tokyo (JP); TOKYO INSTITUTE OF TECHNOLOGY, Tokyo (JP); Maxell, Ltd., Kyoto (JP); TOKYO UNIVERSITY OF SCIENCE FOUNDATION, Tokyo (JP)

(21) Appl. No.: 18/844,991

(22) PCT Filed: Feb. 24, 2023
(86) PCT No.: PCT/JP2023/006867

§ 371 Date: Sep. 9, 2024

(30) Foreign Application Priority Data
Mar. 10, 2022 (JP) 2022-037191

(51) Int. Cl. H01Q 15/00; H01Q 15/14

(52) U.S. Cl. CPC H01Q 15/0013; H01Q 15/14

(57) ABSTRACT

An electric-wave reflector that can favorably reflect electric waves having predetermined frequencies is provided. An electric-wave reflector includes a first dielectric layer, a resistance layer, a second dielectric layer, and a reflective layer that are stacked sequentially from the surface of the electric-wave reflector on which electric waves are to be incident. The thickness d of the second dielectric layer satisfies d=λ/2, where λ is the center wavelength of electric waves to be reflected by the electric-wave reflector.

### CROSS-REFERENCE TO RELATED APPLICATIONS

The present application is based on PCT/JP2023/006867, filed Feb. 24, 2023, which claims priority to Japanese application number 2022-037191 filed in the Japanese Patent Office on Mar. 10, 2022, the entire contents of both of which are incorporated herein by reference.

### TECHNICAL FIELD

The present disclosure relates to an electric-wave reflector that reflects electric waves, and particularly relates to an electric-wave reflector that can selectively reflect electric waves in a predetermined frequency band.

### BACKGROUND ART

Techniques for utilizing centimeter waves having a frequency band of several gigahertz (GHz), a millimeter wave band having frequencies of 30 GHz to 100 GHz, and electric waves having frequencies in a terahertz (THz, 100 GHz or more) band, which are electric waves in a frequency band higher than the millimeter-wave band, have been researched in recent years. Such electric waves are to be used for, e.g., mobile communication such as mobile phones, wireless LANs, and electric toll collection (ETC) systems.

In response to such a technical trend of utilizing electric waves having high frequencies, it is conceivable that it is becoming more necessary for electric-wave absorbers, which absorb unnecessary electric waves, to absorb electric waves in a high frequency band that is not lower than the millimeter-wave band.

As electric-wave absorbers that suppress reflection of unnecessary electric waves and thus absorb the electric waves, electric-wave absorbers of electric-wave interference types (also referred to as reflective types) have been known. An electric-wave absorber of the electric-wave interference type includes a dielectric layer, a resistance film on the surface of the dielectric layer on which electric waves are to be incident, and a reflective layer on the opposite back surface of the dielectric layer. The reflective layer reflects electric waves. Because the phase of electric waves reflected to the outside by the reflective layer and the phase of electric waves reflected by the surface of the resistance film are shifted from each other by a half of the wavelength, the electric waves reflected by the electric-wave absorber cancel each other out and thus are absorbed. The electric-wave interference type electric-wave absorbers can be produced easily, are lightweight, and thus are advantageous in cost reduction, as compared with electric-wave absorbers that magnetically absorb electric waves with magnetic particles.

The present inventors proposed an electric-wave absorbing sheet as a thin electric-wave absorber of the electric-wave interference type. In the electric-wave absorbing sheet, a resistance film on a surface of a dielectric layer is a conductive organic polymer film, so that the electric-wave absorbing sheet can favorably absorb electric waves in a desired frequency band, and is very flexible and easy to handle (see Patent Document 1).

### PRIOR ART DOCUMENT

### Patent Document

### Patent Document 1: WO 2018/088492

### Problems to be Solved

The above-described conventional electric-wave absorbers are used to absorb undesired electric waves to reduce noise factors, and thus allow electric-wave communication techniques to be spread in a good environment.

Alternatively, it is also possible to remove undesired electric waves by favorably reflecting electric waves in a desired frequency band while suppressing reflection of electric waves having undesired frequencies. As the frequency of an electric wave increases, especially from the millimeter-wave band to the terahertz band, the straightness of the electric wave improves. To transmit an electric wave having a high frequency to a desired location, it is important to place reflectors in the path of the electric wave to reflect the electric wave.

In order to solve the above-described and other problems, embodiments are directed to an electric-wave reflector that can favorably reflect electric waves having predetermined frequencies.

### Means for Solving Problems

An electric-wave reflector disclosed in the present application to solve the above-described problem includes a first dielectric layer, a resistance layer, a second dielectric layer, and a reflective layer that are stacked sequentially from the surface of the electric-wave reflector on which electric waves are to be incident. The thickness d of the second dielectric layer satisfies d=λ/2, where λ is the center wavelength of electric waves to be reflected by the electric-wave reflector.

### Effects of the Embodiments

The electric-wave reflector disclosed in the present application includes the first dielectric layer, the resistance layer, the second dielectric layer, and the reflective layer that are stacked sequentially. Because the thickness d of the second dielectric layer satisfies d=λ/2, where λ is the center wavelength of the electric waves to be reflected, the phase of the electric waves that have been incident on the electric-wave reflector and then been reflected by the resistance layer is superimposed on the phase of the electric waves that have been incident on the electric-wave reflector and then been reflected by the reflective layer. Thus, the electric waves with desired frequencies can be strongly reflected.

### BRIEF DESCRIPTION OF DRAWINGS

FIG. 1 is a partial cross-sectional view illustrating a first configuration of an electric-wave reflecting sheet of the present embodiment.

FIG. 2 are a model diagram and an equivalent-circuit diagram that are used for a simulation for confirming the electric-wave reflecting property of the electric-wave reflecting sheet of the present embodiment. FIG. 2(a) is the equivalent-circuit diagram of the electric-wave reflecting sheet of the present embodiment. FIG. 2(b) is the model diagram of the electric-wave reflecting sheet used for examination.

FIG. 3 is a model diagram illustrating the configuration of an electric-wave reflecting sheet used for the simulation and the configuration of an actually made electric-wave reflecting sheet.

FIG. 4 is a graph in which the reflection attenuation property of the actually made electric-wave reflecting sheet of the first configuration is compared with the simulation results.

FIG. 5 is a partial cross-sectional view illustrating a second configuration of the electric-wave reflecting sheet of the present embodiment.

FIG. 6 is a graph in which the reflection attenuation property of an actually made electric-wave reflecting sheet is compared with simulation results.

### DETAILED DESCRIPTION

An electric-wave reflector disclosed in the present application includes a first dielectric layer, a resistance layer, a second dielectric layer, and a reflective layer that are stacked sequentially from the surface of the electric-wave reflector on which electric waves are to be incident. The thickness d of the second dielectric layer satisfies d=λ/2, where λ is the center wavelength of electric waves to be reflected by the electric-wave reflector.

The center wavelength λ of the electric waves to be reflected by the electric-wave reflector is the wavelength of the electric waves propagating through the second dielectric layer.

Such a configuration can superimpose the phase of the electric waves that have been incident on the electric-wave reflector and been reflected by the resistance layer on the phase of the electric waves that have been incident on the electric-wave reflector, been transmitted by the second dielectric layer, and then reflected by the reflective layer, and thus can strengthen the reflected electric waves. Further, a synthetic effect of the electric waves reflected by the surface of the electric-wave reflector, the electric waves reflected by the resistance layer, and the electric waves reflected by the reflective layer allows electric waves in a wide frequency band to be reflected. The electric-wave reflecting property of the electric-wave reflector sharply changes in a band of approximately 0.5 times the center frequency of its reflection band and in a band of approximately 1.5 times the center frequency of its reflection band, and thus can have a filter property.

The center frequency of the electric waves to be reflected by the electric-wave reflector may be 100 GHz or more and 450 GHz or less.

The resistance layer may have an electric resistance of 80 Ω/sq or more and 250 Ω/sq or less. Because the electric resistance of the resistance layer is in a range of 80 to 250 Ω/sq, the balance between the electric waves reflected by the resistance layer and the electric waves transmitted by the resistance layer improves, and in particular, the electric waves in a several hundred GHz band can be favorably reflected.

The second dielectric layer may be adhesive. The adhesion of the second dielectric layer can adhere the resistance layer, the second dielectric layer, and the reflective layer to each other without the aid of an adhesive. Thus, the electric-wave reflector can be produced at low cost.

The resistance layer may be any of a conductive organic polymer film, a sputtered film, or a deposited film.

In the present disclosure, the first dielectric layer, the resistance layer, the second dielectric layer, and the reflective layer may each be in the form of a thin film, so that the electric-wave reflector as a whole is in the form of a flexible sheet. The electric-wave reflector in the form of a flexible sheet is easy to handle when, e.g., being placed at a desired location.

Hereinafter, the electric-wave reflector disclosed in the present application will be described with reference to the drawings.

Here, the electric-wave reflector disclosed in the present application will be described by exemplifying an electric-wave reflecting sheet. The electric-wave reflecting sheet has a sufficiently small thickness relative to its main-surface area and thus can be recognized as a sheet. In this way, the concept of the electric-wave reflector disclosed in the present application includes both an electric-wave reflecting sheet recognized as a sheet based on the relationship between its surface area and thickness, and an electric-wave reflecting block that is relatively thick and thus recognized as a block shape as a whole.

The electric-wave reflector disclosed in the present application uses the interference of electric waves via the dielectric layers to increase the amount of reflection of predetermined frequencies. The electric-wave reflector mainly targets a high frequency band that is not lower than the millimeter-wave band. In such a high frequency band, the wavelength λ, which is the reciprocal of a frequency, is small, as described below. Thus, the dielectric layers of the electric-wave reflector are not very thick. The electric-wave reflector in the form of a thin sheet is convenient because it is less likely to interfere with its surroundings when it is located at a predetermined position in an electric-wave path. Therefore, it is more common to form the electric-wave reflector disclosed in the present application into a form of a sheet having a certain surface area and a small thickness.

### EMBODIMENT

### First Configuration

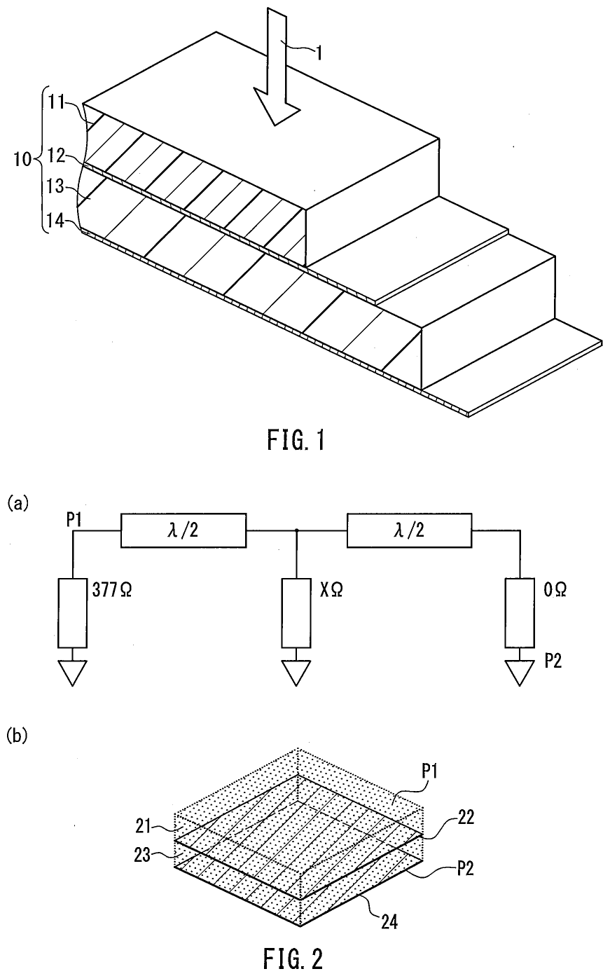

FIG. 1 is a partial cross-sectional perspective view illustrating a first configuration of an electric-wave reflecting sheet (electric-wave reflector) of the present embodiment.

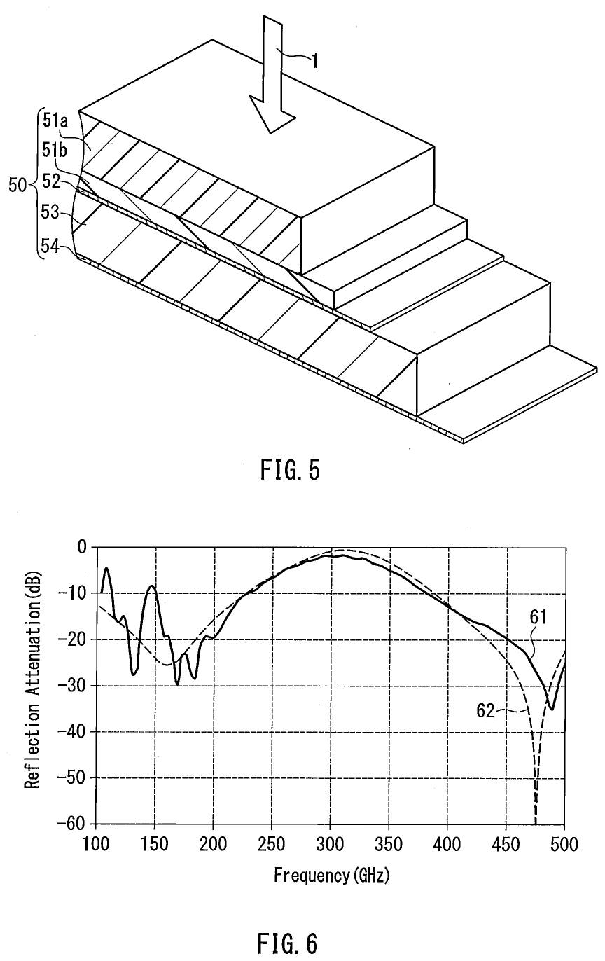

FIG. 1 and FIG. 5 illustrating a second configuration are each for easy understanding of the configurations of the electric-wave reflecting sheet of the present embodiment. In FIGS. 1 and 5, the sizes of components, especially the thicknesses of layers, may not faithfully reflect the actual sizes.

### Configuration of Whole Electric-Wave Reflecting Sheet

An electric-wave reflecting sheet 10 of the first configuration exemplified in the present embodiment includes a first dielectric layer 11, a resistance layer 12, a second dielectric layer 13, and a reflective layer 14 that are stacked sequentially from the surface of the electric-wave reflecting sheet 10 on which electric waves 1 to be reflected are to be incident.

In the electric-wave reflecting sheet 10 of the first configuration exemplified in FIG. 1, the first dielectric layer 11 is a resin sheet as a substrate onto which the resistance layer 12 is applied and formed.

In the electric-wave reflecting sheet 10 of the present embodiment, the components that sandwich the dielectric layer therebetween reflect electric waves. The electric-wave reflecting sheet 10 makes the reflected electric waves interfere with each other, as in the case of an electric-wave sheet of the electric-wave interference type (also referred to as the reflection type), and thus reflects the electric waves in a predetermined frequency band.

### Details of Each Component

Next, each component of the electric-wave reflecting sheet 10 of the present embodiment will be described.

### Dielectric Layers

Various dielectrics such as titanium oxide, polyvinylidene fluoride, polyester resin, glass, and silicone rubber can be used to form each of the first dielectric layer 11 and the second dielectric layer 13 of the electric-wave reflecting sheet 10 of the present embodiment.

The first dielectric layer 11 and the second dielectric layer 13 may each include only one layer made of one type of material. Alternatively, the first dielectric layer 11 and the second dielectric layer 13 may each include two or more stacked layers that are made of the same type of material or different types of materials. The first dielectric layer 11 and the second dielectric layer 13 may be made of the same dielectric material or different dielectric materials. Further, the number of layers of the first dielectric layer 11 may be different from the number of layers of the second dielectric layer 13.

In the electric-wave reflecting sheet 10 of the present embodiment illustrated in FIG. 1, the first dielectric layer 11 is a polyethylene terephthalate (PET) sheet. The PET sheet has a thickness of 300 μm and is a resin substrate on which the resistance layer 12 is formed, as described above.

The thicknesses of the first dielectric layer 11 and the second dielectric layer 13 can be appropriately determined based on the frequencies of the electric waves 1 to be reflected by the electric-wave reflecting and absorbing sheet 10 and considering the permittivities of the dielectric components that constitute each of the dielectric layers. More specifically, when the center frequency of the electric waves 1 to be reflected by the electric-wave reflecting sheet 10 is from 100 GHz to 450 GHz, the first dielectric layer 11 and the second dielectric layer 12 may each be made of an ordinary dielectric material having a relative permittivity of approximately 2 to 3, and each have a thickness of 160 μm to 500 μm. When the dielectric layer having a relative permittivity of approximately 2 to 3 has a thickness of less than 160 μm, the center wavelength of the electric waves to be reflected by the electric-wave reflecting sheet is more than 450 GHz. When the dielectric layer having a relative permittivity of approximately 2 to 3 has a thickness of more than 500 μm, the center wavelength of the electric waves to be reflected by the electric-wave reflecting sheet is less than 100 GHz. The thickness of each of the first dielectric layer 11 and the second dielectric layer 13 is 300 μm or more and 350 μm or less.

The difference between the thickness of the first dielectric layer 11 and the thickness of the second dielectric layer 13 is may be 100 μm or less.

In the electric-wave reflecting sheet 10 of the first configuration illustrated in FIG. 1, the second dielectric layer 13 is made of an acrylic-based optical clear adhesive (OCA) having light transmittance and adhesion. Because the second dielectric layer 13 is made of the resin material having adhesion, the adhesion of the second dielectric layer 13 can adhere the resistance layer 12 including the first dielectric layer 11 as the substrate on which the resistance layer is formed, and the reflective layer 14 to each other. Thus, the configuration of the electric-wave reflecting sheet 10 is simple. The production easiness of the electric-wave reflecting sheet 10 is improved. The materials and production cost of the electric-wave reflecting sheet 10 are reduced.

Naturally, the resistance layer 12 and the first dielectric layer 11 as its substrate layer, the second dielectric layer 13, and the reflective layer 14 may be adhered together with an adhesive material such as a double-sided adhesive sheet. Alternatively, the layers may be adhered together with an adhesive applied to their surfaces to be adhered together, to form a stack as the electric-wave reflecting sheet 10.

If the first dielectric layer 11 and the second dielectric layer 13 are each made of a transparent material or a material having at least a level of light transmittance, as in the electric-wave reflecting sheet 10 exemplified as the first configuration in FIG. 1, and the resistance layer 12 and the reflective layer 14 are also each made of a material having a light transmittance, the electric-wave reflecting sheet 10 as a whole can have at least a level of total light transmittance. The total light transmittance of the electric-wave reflecting sheet 10 may be 60% or more, e.g., 70% or more.

### Resistance Layer

In the electric-wave reflecting sheet 10 shown in the present embodiment, the resistance layer 12 is disposed between the first dielectric layer 11 and the second dielectric layer 13. The resistance layer 12 has a function of reflecting part of the electric waves 1 that have been transmitted by the first dielectric layer 11 and transmitting the remaining part thereof.

The proportion of the electric waves 1 to be reflected by the resistance layer 12 depends on the electric resistance of the resistance layer 12. The higher electric resistance decreases the proportion of the electric waves to be reflected by the resistance layer 12, and increases the proportion of the electric waves to be transmitted by the resistance layer 12. The proportion of the electric waves to be transmitted by the resistance layer 12 also varies depending on the frequency of the incident electric waves. The higher the frequency of the electric waves 1, the higher the proportion of the electric waves 1 to be transmitted by the resistance layer 12, if the resistance layer 12 has a constant electric resistance.

For the electric-wave reflecting sheet 10 shown as the present embodiment, the center frequency of the electric waves 1 to be reflected is set to 300 GHz, and the electric resistance of the resistance layer 12 is 130 Ω/sq. When the center frequency of the electric waves 1 to be reflected by the electric-wave reflecting sheet 10 is 300 GHz, the electric resistance of the resistance layer 12 may be 80 Ω/sq or more and 250 Ω/sq or less, so that the electric waves 1 in a frequency band whose center is 300 GHz can be favorably reflected. When the electric resistance of the resistance layer 12 is less than 80 Ω/sq or is more than 250 Ω/sq, the balance between the electric waves 1 to be reflected by the resistance layer 12 and the electric waves 1 to be transmitted by the resistance layer 12 and then reflected by the reflective layer 14 may be lost, and thus the frequency band of the electric waves to be reflected by the electric-wave reflecting sheet 10 may become narrower, or the amount of reflection of the electric waves that have the center frequency may decrease.

The resistance layer 12 of the electric-wave reflecting sheet 10 of the present embodiment illustrated in FIG. 1 is not limited as long as the resistance layer 12 has a surface electric resistance within a predetermined range. More specifically, the resistance layer 12 may favorably be a conductive organic polymer film, a sputtered film, or a deposited film. The conductive organic polymer film, the sputtered film, and the deposited film may be used because their electric resistances can be regulated with their film thicknesses or molding densities, and thus the resistance layer 12 having a desired electric resistance can be easily formed.

The conductive organic polymer used as the resistance layer 12 is a conjugated conductive organic polymer. The conductive organic polymer used as the resistance layer 12 may be polythiophene, a derivative thereof, polypyrrole, or a derivative thereof.

Alternatively, the resistance layer 12 may be made of an organic polymer whose main chain includes a π conjugated system. For example, polyacetylene-based conductive polymers, polyphenylene-based conductive polymers, polyphenylene vinylene-based conductive polymers, polyaniline-based conductive polymers, polyacene-based conductive polymers, polythiophene vinylene-based conductive polymers, and copolymers of these can be used as the resistance layer 12.

The conductive organic polymer used as the resistance layer 12 may contain polyanion as its counter anion. Although the polyanion is not limited, the polyanion may contain an anion group that enables the above-described conjugated conductive organic polymer used as the resistance layer 12 to cause chemical oxidation doping. Examples of such an anion group include groups expressed by general formulae —O—SO₃X, —O—PO(OX)₂, —COOX, and —SO₃X (in each formula, X represents a hydrogen atom or an alkali metal atom). Among them, the groups expressed by —SO₃X and —O—SO₃X may be used because of their excellent doping effects on the conjugated conductive organic polymers.

One of the conductive organic polymers may be used alone, or two or more of the conductive organic polymers may be used in combination. Among the materials exemplified above, polymers composed of one or two selected from the group consisting of polypyrrole, poly(3-methoxythiophene), poly(3,4-ethylenedioxythiophene), poly(2-aniline sulfonic acid), and poly(3-aniline sulfonic acid) may be used because they further increase transparency and conductivity.

A combination of the conjugated-system conductive organic polymer and the polyanion is poly(3,4-ethylenedioxythiophene: PEDOT) and polystyrene sulfonic acid (PSS) may be used.

A dopant may be added to the resistance layer 12 of the electric-wave reflecting sheet 10 of the present embodiment to control the electric conductivity of the conductive organic polymer, and thus obtain a predetermined electric resistance. Examples of the dopant include halogens such as iodine and chlorine, Lewis acids such as BF₃ and PF₅, proton acids such as nitric acid and sulfuric acid, transition metals, alkali metals, amino acids, nucleic acids, surfactants, pigments, chloranil, tetracyanoethylene, and tetracyanoquinodimethane (TCNQ).

The content of the conductive organic polymer in the resistance layer 12 is may be 10 mass % or more and 35 mass % or less based on the total mass of solids contained in the composition of the resistance layer 12. When the content of the conductive organic polymer is less than 10 mass %, the conductivity of the resistance layer 12 tends to deteriorate. Accordingly, because the surface electric resistance of the resistance layer 12 is within a predetermined range for impedance matching, the thickness of the resistance layer 12 increases, and thus the thickness of the electric-wave reflecting sheet 10 as a whole tends to increase, and the optical characteristics of the electric-wave reflecting sheet 10 also tend to deteriorate if the electric-wave reflecting sheet 10 has light transmittance. Meanwhile, if the content of the conductive organic polymer exceeds 35 mass %, the structure of the conductive organic polymer causes less suitable coating of the resistance layer 12, and thus it is difficult to form a good resistance layer 12, and the haze of the resistance layer 12 tends to increase and thus lowers the optical characteristics of the electric-wave reflecting sheet 10 if the electric-wave reflecting sheet 10 has light transmittance.

The resistance layer 12 may contain a carbon material such as carbon microcoils, carbon nanotubes, or graphene.

The carbon microcoils are a type of vapor grown carbon fiber mainly obtained by catalytic thermal decomposition of acetylene. The carbon microcoils are a material having a micron coil diameter and a three-dimensional helical structure. The carbon microcoils may have a diameter of 1 to 10 μm. Carbon fibers that constitute the carbon microcoils may have a diameter of 0.1 to 1 μm. The carbon microcoils may have a length of 1 to 10 mm.

The carbon nanotubes can be obtained using vapor growth methods such as arc discharge, laser vaporization, and thermal decomposition. The resistance layer 12 of the electric-wave reflecting sheet 10 of the present embodiment may contain carbon nanotubes having a layer or a plurality of layers.

The graphene can be obtained by, e.g., release transfer, SiC thermal decomposition, chemical vapor deposition, or cutting carbon nanotubes. The graphene used as the resistance layer 12 of the electric-wave reflecting sheet 10 of the present embodiment may be flake powder graphene in view of easy acquisition of a desired aspect ratio and the orientation in the electric-wave reflecting sheet 10.

A water-soluble polyester resin may be used as a resin in which the above-described carbon materials are dispersed.

To form the resistance layer 12, a coating composition as a coating material for formation of the resistance layer 12 may be applied onto a resin substrate, as described above. Then, the applied coating composition may be dried.

Examples of a method for applying the coating material for formation of the resistance layer onto the substrate include bar coating, reverse roll coating, gravure coating, micro gravure coating, slot-die coating, dip coating, spin coating, slit-die coating, and spray coating. The drying after the application is not limited as long as it can vaporize solvent components of the coating material for formation of the resistance layer. The drying is may be performed at 100 to 150° C. for 5 to 60 minutes. If the solvent remains on the resistance film, its strength tends to deteriorate. Examples of the drying method include hot-air drying, heat drying, vacuum drying, and natural drying. The applied film may be cured by irradiating it with ultraviolet (UV) light or electron beam (EB), if necessary, to form the resistance layer 12.

Although the substrate used for formation of the resistance layer 12 is not limited, a transparent substrate with transparency may be used. Examples of materials of such a transparent substrate include resin, rubber, glass, ceramics, acrylic resin, and silicone resin, or various dielectrics such as an OCA. As described above, in the electric-wave reflecting sheet 10 exemplified in the present embodiment, the resistance layer 12 is the PET film having a thickness of 300 μm.

### Reflective Layer

The reflective layer 14 reflects the electric waves 1 that have been transmitted by the second dielectric layer 13. Unlike the resistance layer 12, the reflective layer 12 does not need to transmit the electric waves 1. Thus, the reflective layer 14 may have a surface electric resistance as low as possible, e.g., a surface electric resistance of 0 Ω/sq. The reflective layer 14 may be a metal foil or a metal sheet.

The reflective layer 14 may be a metal foil to allow the electric-wave reflecting sheet 10 to be flexible. Various metal foils such as a copper foil, an aluminum foil, and a gold foil can be used. Among them, an aluminum foil may be used as the reflective layer 14 considering the cost and influences of oxidation in the air. A metal foil that forms the reflective layer 14, e.g., an aluminum foil, can be easily made by rolling a metal material. If the reflective layer 14 is a metal film deposited on a surface of a nonmetal material, vapor deposition methods may be selected for forming various conventional deposited films, considering, e.g., a high temperature that a metal material to be deposited can resist and a high temperature that a nonmetal material as its substrate, e.g., resin, can resist.

If the reflective layer 14 is an aluminum foil so that the electric-wave reflecting sheet 10 is flexible, the thickness of the reflective layer 14 may be 1 μm to 20 μm.

The reflective layer 14 of the electric-wave reflecting sheet 10 of the present embodiment shown in FIG. 1 may be a deposited film made of a conductive material such as a metal. For example, a film of a metal material may be directly deposited on a surface of the second dielectric layer 13 that is opposite the surface of the second dielectric layer 13 on which the resistance layer 12 is present. If the metal film is deposited on the back surface of the second dielectric layer 13, a gap is unlikely to occur between the second dielectric layer 13 and the reflective layer 14, compared with the case where the second dielectric layer 13 and the reflective layer 14 are separately made and placed in close contact with each other. Thus, the electric waves 1 that have been transmitted by the second dielectric layer 13 can be reflected at the position of the back surface of the second dielectric layer 13. Therefore, it becomes easy to provide the electric-wave reflecting sheet 10 with a desired electric-wave reflecting property.

If the reflective layer 14 is a deposited film, it is necessary to make the density of the conductive material of the deposited film uniform and sufficient, compared with a case where the reflective layer 14 is a metal foil. The results of the examination by the present inventors show that having the surface electric resistance of the reflective layer is 1 Ω/sq or less, and that the thickness of the deposited metal film is adequately controlled so that the surface electric resistance becomes a desired value or less.

To provide the electric-wave reflecting sheet 10 with not only flexibility but also light transmittance, the reflective layer 14 may be made of a conductive mesh including conductive fibers. The conductive mesh may include weaved polyester monofilaments as its mesh, and a metal deposited on the mesh to make it conductive. The metal may be copper or silver, which has a high conductivity. To reduce reflection by the metal film that covers the surface of the mesh, some products additionally include a black antireflective layer on the outer surface of the metal film.

Alternatively, the reflective layer 14 may be a conductive metal grid including metal wires arranged vertically and laterally. The metal wires are, e.g., thin copper wires having a diameter of several ten to several hundred μm.

The reflective layer 14 as the above-described mesh or conductive metal grid has the minimum thickness to secure its flexibility and light transmittance as long as the reflective layer 14 has a necessary surface electric resistance.

The aperture ratio of the reflective layer 14 as the mesh or conductive metal grid may be large enough to secure its light transmittance, and small enough to surely reflect electric waves on the surface of the reflective layer 14 and thus improve the electric-wave absorbing property of the electric-wave reflecting sheet 10. The examination of the present inventors shows that the aperture ratio may be 35% or more and 85% or less, e.g., 35% or more and 75% or less.

### Adhesive Layer

The electric-wave reflecting sheet 10 of the present embodiment may include an adhesive layer, which is not illustrated in FIG. 1, on the back surface of the reflective layer 14. The adhesive layer allows the electric-wave reflecting sheet 10 to be easily placed at a predetermined position.

As the adhesive layer, a publicly known material used as an adhesive layer of, e.g., an adhesive tape, or an acrylic-based adhesive, a rubber-based adhesive, or a silicone-based adhesive may be used. A tackifier or a crosslinking agent may be used to adjust the adhesive strength to an adherend and reduce adhesive residues. The adhesive strength to the adherend may be 5 N/10 mm to 12 N/10 mm. If the adhesive strength is less than 5 N/10 mm, the electric-wave reflecting sheet 10 may easily peel off of the adherend or unintentionally move on the adherend. If the adhesive strength is greater than 12 N/10 mm, it is difficult to peel the electric-wave reflecting sheet 10 off of the adherend.

The thickness of the adhesive layer may be 20 μm to 100 μm. If the thickness of the adhesive layer is thinner than 20 μm, its adhesive strength may become smaller and thus the electric-wave reflecting sheet 10 may easily peel off of the adherend or unintentionally move on the adherend. If the thickness of the adhesive layer is more than 100 μm, it is more difficult to peel the electric-wave reflecting sheet 10 off of the adherend. If the cohesion of the adhesive layer is small, its adhesive may remain on the adherend from which the electric-wave reflecting sheet 10 has been peeled. Further, the small cohesion may lower the flexibility of the electric-wave reflecting sheet 10 as a whole.

An adhesive layer usable for the electric-wave reflecting sheet 10 of the present embodiment may peelably or unpeelably adhere the electric-wave reflecting sheet 10 to an adherend. The electric-wave reflecting sheet 10 of the present embodiment may not need the adhesive layer, and may be adhered to a target component using various conventional adhering methods.

### EXAMPLES

Hereinafter, the results of examination of the electric-wave reflecting property of the electric-wave reflecting sheet 10 of the present embodiment will be described.

### Electric-Wave Reflecting Property

The present inventors made a model of the electric-wave reflecting sheet disclosed in the present application, and performed a simulation. Further, they actually made an electric-wave reflecting sheet that conformed to the model. They compared the simulation with the actually made electric-wave reflecting sheet in connection with a principle that the electric-wave reflecting property of the electric-wave reflecting sheet disclosed in the present application including the first dielectric layer, the resistance layer, the second dielectric layer, and the reflective layer that are stacked sequentially is obtained, especially the reason why the electric-wave reflector having a high reflecting property in a predetermined frequency bandwidth is obtained, and the possibility that the electric-wave reflecting property can be controlled.

FIG. 2 include an equivalent circuit diagram and a configuration model used for the simulation of the electric-wave reflector (sheet) used by the present inventors for the examination. FIG. 2(a) is the equivalent-circuit diagram. FIG. 2(b) illustrates the model configuration of the electric-wave reflector as the examination target.

The model of the electric-wave reflecting sheet of the present embodiment illustrated in FIG. 2(b) included a first dielectric layer 21, a resistance layer 22, a second dielectric layer 23, and a reflective layer 24 that were stacked sequentially from the surface of the electric-wave reflecting sheet on which electric waves were incident.

The impedance of a port P1, which was the surface of the first dielectric layer 21 in the model, was set considering the relative permittivity of the first dielectric layer so that the impedance of the port P1 was 377Ω at a thickness of a half of the wavelength λ of the incident electric waves. 377Ω is equal to the impedance in the air. Theresistance layer 22 on the back surface of the first dielectric layer 21 had a surface electric resistance of X Ω. The thickness of the second dielectric layer 23 was a half of the wavelength λ of the electric waves. The reflective layer 24 as a port P2 had an electric resistance of 0Ω (=the ground).

In such a configuration, because the thickness of the first dielectric layer 21 was set to λ/2, i.e. a half-wave optical thickness, the electric waves having the wavelength λ were apparently absorbed. Further, because the thickness of the second dielectric layer 23 was set to λ/2, the phase of the electric waves reflected by the resistance layer 22 was superimposed on the phase of the electric waves reflected by the reflective layer 24, and thus the electric waves 1 were strongly reflected. Here, the surface electric resistance X of the resistance layer 22 was set to a smaller value, e.g., 130Ω, than 377Ω, which was the impedance of the surface of the first dielectric layer. Thus, the effect on the port 2 (P2) side was suppressed. It is conceivable that such a combination of the electric-wave reflecting effect of the first dielectric layer 21 and the electric-wave reflecting effect of the second dielectric layer 23 provides the strong electric-wave reflecting property in a certain frequency bandwidth whose center is a desired frequency.

An Ansys HFSS simulation that used the equivalent circuit illustrated in FIG. 2(a) was performed to determine the frequency characteristics of the electric-wave reflection attenuation amounts of the electric-wave reflecting sheet shown in the present embodiment. Further, an electric-wave reflecting sheet was actually made to actually measure the frequency characteristics of its reflection attenuation amounts. The actually made electric-wave reflecting sheet was also used as the model of the Ansys HFSS simulation.

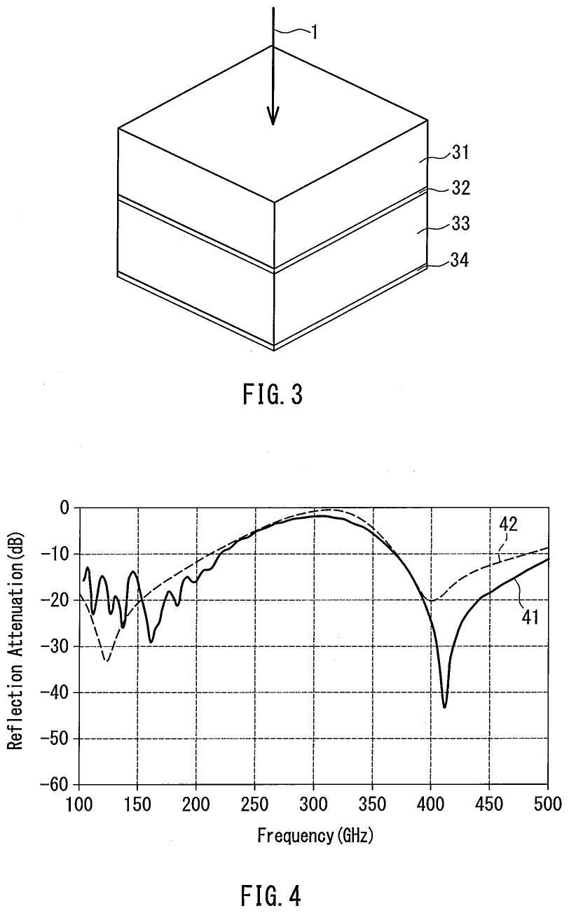

FIG. 3 illustrates a specific model of the electric-wave reflector used in the simulation.

In the simulation, the reflection attenuation amounts of a stack were calculated for frequencies of 100 GHz to 500 GHz. The stack corresponded to the first configuration of the electric-wave reflecting sheet illustrated in FIG. 1. The stack was a stack of a first dielectric layer 31, a resistance layer 32, a second dielectric layer 33, and a reflective layer 34. The first dielectric layer 31 had a relative permittivity of 3.2 and a thickness of 300 μm. The resistance layer 32 had an electric resistance of 130 Ω/sc. The second dielectric layer 33 had a relative permittivity of 2.55 and a thickness of 300 μm. The reflective layer 34 had an electric resistance of 0 Ω/sc (=the ground).

The actual electric-wave absorbing sheet included a PET film as the first dielectric layer 31, a PEDOT resistance layer 32, an acrylic OCA as the second dielectric layer 33, and an aluminum foil as the reflective layer 34. The PET film had a relative permittivity of 3.2 and a thickness of 300 μm. The PEDOT resistance layer 32 was formed on the PET film, and had a surface electric resistance of 140 Ω/sq. The acrylic OCA had a relative permittivity of 2.55 and a thickness of 300 μm.

The frequency characteristics of the reflection attenuation amounts of the electric-wave reflecting sheet were measured for frequencies of 100 GHz to 500 GHz with a THZ-TDS TAS7500SP (product name) manufactured by Advantest Corporation. The attenuation amounts of the reflected waves relative to the incident waves were determined as the reflection attenuation amounts for the electric-wave reflecting property, and represented as dB, as in the results of the simulation.

FIG. 4 shows the frequency characteristics of the reflection attenuation amounts of the electric-wave reflecting sheet.

In FIG. 4, a solid line (reference numeral 41) represents the measurement results of the actually made electric-wave reflecting sheet, and a broken line (reference numeral 42) represents the results of the simulation.

FIG. 4 shows that the measurement results of the actually made model and the simulation results had substantially the same tendency, and that the simulation allows an electric-wave reflecting sheet with a desired electric-wave reflecting property to be designed.

### Second Configuration

Hereinafter, a second configuration of the electric-wave reflector disclosed in the present application will be described. The second configuration is an example in which the first dielectric layer includes a plurality of stacked dielectric layers.

FIG. 5 is a partial cross-sectional perspective view illustrating the second configuration of the electric-wave reflecting sheet shown in the present embodiment.

In an electric-wave reflecting sheet 50 of the second configuration illustrated in FIG. 5, a first dielectric layer 51 includes two dielectric layers including a surface dielectric layer 51a and a resin substrate 51b. The surface dielectric layer 51a is made of a dielectric material. The resin substrate 51b is used for formation of a reflective layer 52. This configuration is the difference between the electric-wave reflecting sheet 50 and the electric-wave reflecting sheet 10 of the first configuration illustrated in FIG. 1.

As described above, in the electric-wave reflector disclosed in the present application, the first dielectric layer and the second dielectric layer may each include a plurality of stacked dielectric films. Thus, the first dielectric layer may be a stack of a substrate and a dielectric film, as in the second configuration illustrated in FIG. 5. The substrate is used for formation of the resistance layer. The substrate is made of a resin material having a predetermined permittivity. The dielectric film is made of another dielectric material.

In the electric-wave reflecting sheet 50 of the second configuration illustrated in FIG. 5, the surface dielectric layer 51a is an acrylic-based OCA film having a thickness of 250 μm, and the resin substrate 51b for formation of the resistance layer 52 is a polyethylene terephthalate (PET) sheet having a thickness of 50 μm.

A second dielectric layer 53 is made of an acrylic-based optical clear adhesive (OCA) having light transmittance and adhesion, as in the case of the second dielectric layer 13 of the first configuration. As a reflective layer 54, various metal foils such as a copper foil, an aluminum foil, and a gold foil may be used, as in the case of the reflective layer 14 of the first configuration.

FIG. 6 shows the frequency characteristics of the reflection attenuation amounts of the second configuration illustrated in FIG. 5, in which the first dielectric layer includes the two layers of dielectric films.

In FIG. 6, a solid line (reference numeral 61) represents the measurement results of an actually made electric-wave reflecting sheet, and a broken line (reference numeral 62) represents simulation results.

The frequency characteristics of the second configuration illustrated in FIG. 6 were determined using the above-described simulation. In the simulation, the reflection attenuation amounts of a stack were calculated for frequencies of 100 GHz to 500 GHz. The stack was a stack of a first dielectric layer, a resistance layer, a second dielectric layer, and a reflective layer. The first dielectric layer was a stack of a surface dielectric layer and a resin substrate. The first dielectric layer had a total thickness of 300 μm. The surface dielectric layer had a relative permittivity of 2.55 and a thickness of 250 μm. The resin substrate had a relative permittivity of 3.2 and a thickness of 50 μm. The resistance layer had a surface electric resistance of 130 Ω/sc. The second dielectric layer had a relative permittivity of 2.55 and a thickness of 300 μm. The reflective layer had a surface electric resistance of 0 Ω/sc (=the ground).

The actual electric-wave absorbing sheet included a dielectric layer as the first dielectric layer, a PEDOT resistance layer, an acrylic OCA as the second dielectric layer, and an aluminum foil as the reflective layer. The dielectric layer as the first dielectric layer included an acrylic-based OCA and a PET film as the resin substrate. The dielectric layer as the first dielectric layer had a total thickness of 300 μm. The acrylic-based OCA of the dielectric layer had a relative permittivity of 2.55 and a thickness of 250 μm. The PET film as the resin substrate had a relative permittivity of 3.2 and a thickness of 50 μm. The PEDOT resistance layer was formed on the resin substrate, and had a surface electric resistance of 140 Ω/sq. The acrylic OCA as the second dielectric layer had a relative permittivity of 2.55 and a thickness of 300 μm.

The frequency characteristics of the reflection attenuation amounts of the actual electric-wave reflecting sheet were measured for frequencies of 100 GHz to 500 GHz with a THZ-TDS TAS7500SP (product name) manufactured by Advantest Corporation, as in the case of the first configuration illustrated in FIG. 4. The attenuation amounts of the reflected waves relative to the incident waves were determined as the reflection attenuation amounts for the electric-wave reflecting property, and represented as dB, as in the results of the simulation.

Even if the first dielectric layer included the two stacked dielectric films, the measurement results of the actually made model had substantially the same tendency as that of the simulation results, as illustrated in FIG. 6, as in the case where the first dielectric layer includes only one dielectric layer, as illustrated in FIG. 4. The simulation allows an electric-wave reflecting sheet with a desired electric-wave reflecting property to be designed.

If the first dielectric layer includes only one dielectric film or two stacked dielectric layers, the resulting electric-wave reflector has reflection attenuation amounts that are less than −10 dB, that is, reflects 90% or more of the incident electric waves, in a frequency band of 220 GHz to 370 GHz, as illustrated in FIGS. 4 and 6.

As illustrated in FIGS. 4 and 6, the reflection attenuation amounts of the electric-wave reflecting sheet shown in the present embodiment increase in electric wave frequencies outside the frequency band in which the electric waves are favorably reflected. For example, FIG. 4 shows that the electric-wave reflecting sheet of the first configuration has the reflection attenuation amounts that are more than −20 dB, and thus absorbs 99% or more of the electric waves, that is, reflects 1% or less of the electric waves, in the electric wave frequencies of 180 GHz or less or in the electric wave frequencies of 390 GHz or more.

In this way, the electric-wave reflecting sheet of the present embodiment reflects only electric waves in a desired frequency band by favorably absorbing electric waves whose frequencies are outside the desired reflection frequencies. The examination of the present inventors confirmed that the electric-wave reflecting sheet often exhibits such frequency characteristics that its reflection attenuation property sharply increases in a band of approximately 0.5 times the center frequency of the reflective band and in a band of approximately 1.5 times the center frequency of the reflective band. As a result, the electric-wave reflecting sheet has such a filter property that the electric-wave reflecting sheet favorably reflects electric waves near the center frequency of the reflective band, and absorbs (does not reflect) electric waves in a frequency band around the reflective band.

Thus, if the electric-wave reflecting sheets of the present embodiment are located in an electric-wave path, they allow electric waves, especially electric waves in a high frequency band, where the straightness of the electric waves is high, to propagate along the predetermined path. For example, the high frequency band is not lower than the millimeter-wave band. The electric-wave reflector of the present embodiment absorbs electric waves outside a predetermined frequency band, and thus can avoid the possibility of reflection of the undesired electric waves. For example, if the electric-wave reflecting sheets of the present embodiment are located at predetermined positions in an electric-wave path on inner walls of a room, such as a meeting room and a sitting room in an office, the electric-wave reflecting sheets allow electric waves to be favorably received at each position in the room where obstacles are present while not causing reflection of undesired electric waves. In such an electric-wave receiving environment, the C/N ratio is high.

As described above, the electric-wave reflecting sheet shown in the present embodiment includes the first dielectric layer, the resistance layer, the second dielectric layer, and the reflective layer that are stacked sequentially from the surface of the electric-wave reflecting sheet on which electric waves are to be incident, so that the electric-wave reflecting property via the first dielectric layer, the electric-wave reflecting property via the second dielectric layer, and the electric-wave reflecting property via the first dielectric layer and the second dielectric layer are combined. Because the thickness d of the second dielectric layer satisfies d=λ/2, where λ is the center wavelength of electric waves to be reflected by the electric-wave reflecting sheet, the electric waves reflected via the second dielectric layer are superimposed on each other, and thus the electric-wave reflector can have a high reflecting property for electric waves in a wide frequency band whose center is a predetermined frequency.

Although the electric-wave reflecting property of the electric-wave reflecting sheet as a whole is varied by especially changing the relative permittivity and thickness of the first dielectric layer or changing the electric resistance of the resistance layer, it was confirmed that the above-described simulation allows the electric-wave absorbing property (=the frequency characteristics of the reflection amounts) of the electric-wave reflecting sheet as a whole to be calculated. Thus, it is possible to design an electric-wave reflecting sheet having a suitable electric-wave reflecting property.

The above embodiment describes only the configuration of the electric-wave absorber (sheet) including the two dielectric layers including the first dielectric layer and the second dielectric layer. However, the electric-wave reflector (sheet) disclosed in the present application is not limited to this configuration.

The electric-wave reflector may include two or more combinations of the resistance layer and the dielectric layer to reflect electric waves in a desired band with the three or more dielectric layers. For example, in the configuration of the electric-wave reflecting sheet illustrated in FIG. 1 or 5, a second resistance layer and a third dielectric layer may be additionally stacked between the first dielectric layer and the resistance layer. Even if the electric-wave reflector (sheet) includes a plurality of resistance layers and three or more dielectric layers, the electric-wave reflector (sheet) has a better electric-wave reflecting property because the thickness of the second dielectric layer near the reflective layer is λ/2, where λ is the center wavelength of electric waves to be reflected, and thus the amount of reflection of the electric waves having the center wavelength increases.

Because the electric-wave reflecting sheet disclosed in the present application includes the plurality of dielectric layers, the resistance layer, and the reflective layer that are each made of a flexible material, the electric-wave reflecting sheet as a whole is flexible and thus easy to handle when it is placed at a desired location.

The electric-wave reflector not only is in the form of a sheet but also may be in the form of a block having a predetermined thickness relative to its surface area. If the electric-wave reflector in the form of a block as a whole is flexible, the electric-wave reflector is easier to handle when it is placed at a predetermined location, and thus is very practical.

The electric-wave reflecting block may include a plurality of dielectric layers, a resistance layer, and a reflective layer that are each made of a material having light transmittance. If such electric-wave reflecting blocks are arranged like tiles on, e.g., a window or a transparent wall, it is possible to see through them. In this case, because the electric-wave absorbing effects of the plurality of dielectric layers are also combined, the electric-wave reflector has a broad reflection attenuation property and thus can selectively reflect electric waves in a wider frequency band.

### INDUSTRIAL APPLICABILITY

The electric-wave absorber disclosed in the present application includes the first dielectric layer, the resistance layer, the second dielectric layer, and the reflective layer that are stacked sequentially. Because the thickness d of the second dielectric layer satisfies d=λ/2, where λ is the center wavelength of electric waves to be reflected, the electric-wave reflector has a high reflecting property in a wavelength region (frequency region) around the electric wave having the center wavelength. The electric-wave reflector disclosed in the present application can favorably reflect electric waves in a predetermined frequency band, and can absorb electric waves in a frequency band around the predetermined frequency band to reduce the amount of reflection of the absorbed electric waves.

The present disclosure is not limited to only the above-described embodiments, which are merely exemplary. It will be appreciated by those skilled in the art that the disclosed systems and/or methods can be embodied in other specific forms without departing from the spirit of the disclosure or essential characteristics thereof. The presently disclosed embodiments are therefore considered to be illustrative and not restrictive. The disclosure is not exhaustive and should not be interpreted as limiting the claimed invention to the specific disclosed embodiments. In view of the present disclosure, one of skill in the art will understand that modifications and variations are possible in light of the above teachings or may be acquired from practicing of the disclosure.

1. An electric-wave reflector comprising:
a first dielectric layer,
a resistance layer,
a second dielectric layer, and
a reflective layer that are stacked sequentially from a surface of the electric-wave reflector on which electric waves are to be incident,
wherein a thickness d of the second dielectric layer satisfies d=λ/2, where λ is a center wavelength of electric waves to be reflected by the electric-wave reflector.

2. The electric-wave reflector according to claim 1, wherein a center frequency of the electric waves to be reflected by the electric-wave reflector is 100 GHz or more and 450 GHz or less.

3. The electric-wave reflector according to claim 1, wherein the resistance layer has a surface electric resistance of 80 Ω/sq or more and 250 Ω/sq or less.

4. The electric-wave reflector according to claim 1, wherein the second dielectric layer is adhesive.

5. The electric-wave reflector according to claim 1, wherein the resistance layer is any of a conductive organic polymer film, a metal film, and a doped film.

6. The electric-wave reflector according to claim 1, wherein the first dielectric layer, the resistance layer, the second dielectric layer, and the reflective layer are each a thin film, so that the electric-wave reflector is a flexible sheet.

7. The electric-wave reflector according to claim 1, wherein the resistance layer has a surface electric resistance less than a surface electric resistance of the first dielectric layer.

8. The electric-wave reflector according to claim 1, wherein the reflective layer is a metal foil.

9. The electric-wave reflector according to claim 1, wherein the reflective layer is a conductive mesh.

10. The electric-wave reflector according to claim 1, wherein a difference in thickness between the first dielectric layer and the second dielectric layer is less than 100 microns.

11. The electric-wave reflector according to claim 1, wherein the resistance layer is a polymer film composed of one or two selected from the group consisting of polypyrrole, poly(3-methoxythiophene), poly(3,4-ethylenedioxythiophene), poly(2-aniline sulfonic acid), and poly(3-aniline sulfonic acid).

12. The electric-wave reflector according to claim 1, wherein a content of a conductive organic polymer in the resistance layer is 10 mass % or more and 35 mass % based on a total mass of solids contained in the resistance layer.

13. The electric-wave reflector according to claim 1, wherein first dielectric includes a surface dielectric layer and a resin substrate, wherein the resin substrate is between the surface dielectric layer and the reflective layer.

14. The electric-wave reflector according to claim 1, wherein the resistance layer has a surface electric resistance of 80 Ω/sq or more and 250 Ω/sq or less.

15. The electric-wave reflector according to claim 1, wherein the second dielectric layer is adhesive.

16. The electric-wave reflector according to claim 1, wherein the resistance layer is any of a conductive organic polymer film, a metal film, and a doped film.

17. The electric-wave reflector according to claim 1, wherein the first dielectric layer, the resistance layer, the second dielectric layer, and the reflective layer are each in a thin film, so that the electric-wave reflector is a flexible sheet.

18. A method of making an electric-wave reflector comprising:
forming a resistance layer on a first dielectric layer on a surface opposite a surface of the first dielectric layer on which electric waves are to be incident;
forming a second dielectric layer on the resistance layer, wherein a thickness d of the second dielectric layer satisfies d=λλ/2, where λ is a center wavelength of electric waves to be reflected by the electric-wave reflector; and
forming a reflective layer on the second dielectric layer.
